(19) United States
(12) Patent Application Publication
(10) Pub. No.: US 2023/0298266 A1
(43) Pub. Date: Sep. 21, 2023

(54) HIERARCHICAL SCENE MODEL

(71) Applicant: Apple Inc., Cupertino, CA (US)

(72) Inventors: Payal Jotwani, Santa Clara, CA (US); Angela Blechschmidt, San Jose, CA (US)

(21) Appl. No.: 18/071,295

(22) Filed: Nov. 29, 2022

Related U.S. Application Data
(63) Continuation of application No. PCT/US21/31930, filed on May 12, 2021.
(60) Provisional application No. 63/031,895, filed on May 29, 2020.

(51) Int. Cl. G06T 17/00; G06V 20/70

(52) U.S. Cl. CPC G06T 17/00; G06V 20/70

(57) ABSTRACT

In one implementation, a method of providing a portion of a three-dimensional scene model includes storing, in the non-transitory memory, a three-dimensional scene model of a physical environment including a plurality of points, wherein each of the plurality of points is associated with a set of coordinates in a three-dimensional space, wherein a subset of the plurality of points is associated with a hierarchical data set including a plurality of layers. The method includes receiving, from an objective-effectuator, a request for a portion of the three-dimensional scene model, wherein the portion of the three-dimensional scene model includes less than all of the plurality of points or less than all of the plurality of layers. The method includes obtaining, by the processor from the non-transitory memory, the portion of the three-dimensional scene model. The method includes providing, to the objective-effectuator, the portion of the three-dimensional scene model.

This application is a continuation of Intl. Patent App. No. PCT/US2021/031930, filed on May 12, 2021, which claims priority to U.S. Provisional Patent App. No. 63/031,895, filed on May 29, 2020, which are both hereby incorporated by reference in their entirety.

### TECHNICAL FIELD

The present disclosure generally relates to three-dimensional scene models and, in particular, to systems, methods, and devices for providing portions of a three-dimensional scene models to objective-effectuators.

### BACKGROUND

A point cloud includes a set of points in a three-dimensional space. In various implementations, each point in the point cloud corresponds to a surface of an object in a physical environment. Point clouds can be used to represent an environment in various computer vision and/or extended reality (XR) applications.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a physical environment with a handheld electronic device surveying the physical environment.

FIGS. 2A and 2B illustrate the handheld electronic device of FIG. 1 displaying two images of the physical environment captured from different perspectives.

FIGS. 3A and 3B illustrate the handheld electronic device of FIG. 1 displaying the two images overlaid with a representation of a point cloud.

FIGS. 4A and 4B illustrate the handheld electronic device of FIG. 1 displaying the two images overlaid with a representation of the point cloud spatially disambiguated into a plurality of clusters.

FIG. 5 illustrates a point cloud data object in accordance with some implementations.

FIGS. 6A and 6B illustrates hierarchical data structures for sets of semantic labels in accordance with some implementations.

FIG. 7 illustrates spatial relationships between a first cluster of points and a second cluster of points in accordance with some implementations.

FIGS. 8A-8F illustrates the handheld electronic device of FIG. 1 displaying images of an XR environment including representations of objective-effectuators.

FIG. 9 is a flowchart representation of a method of providing a portion of three-dimensional scene model in accordance with some implementations.

FIG. 10 is a block diagram of an electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for providing a portion of a three-dimensional scene model. In various implementations, a method is performed at a device including a processor and non-transitory memory. The method includes storing, in the non-transitory memory, a three-dimensional scene model of a physical environment including a plurality of points, wherein each of the plurality of points is associated with a set of coordinates in a three-dimensional space, wherein a subset of the plurality of points is associated with a hierarchical data set including a plurality of layers. The method includes receiving, from an objective-effectuator, a request for a portion of the three-dimensional scene model, wherein the portion of the three-dimensional scene model includes less than all of the plurality of points or less than all of the plurality of layers. The method includes obtaining, by the processor from the non-transitory memory, the portion of the three-dimensional scene model. The method includes providing, to the objective-effectuator, the portion of the three-dimensional scene model.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

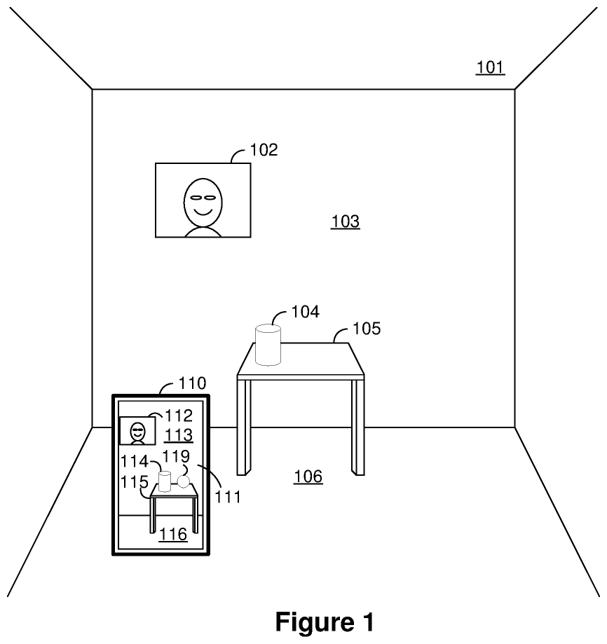

FIG. 1 illustrates a physical environment 101 with a handheld electronic device 110 surveying the physical environment 101. The physical environment 101 includes a picture 102 hanging on a wall 103, a table 105 on the floor 106, and a cylinder 104 on the table 105.

The handheld electronic device 110 displays, on a display, a representation of the physical environment 111 including a representation of the picture 112 hanging on a representation of the wall 113, a representation of the table 115 on a representation of the floor 116, and a representation of the cylinder 114 on the representation of the table 115. In various implementations, the representation of the physical environment 111 is generated based on an image of the physical environment 101 captured with a scene camera of the handheld electronic device 110 having a field-of-view directed toward the physical environment 101.

In addition to the representations of real objects of the physical environment 101, the representation of the physical environment 111 includes a virtual object 119 displayed on the representation of the table 115.

In various implementations, the handheld electronic device 110 includes a single scene camera (or single rear-facing camera disposed on an opposite side of the handheld electronic device 110 as the display). In various implementations, the handheld electronic device 110 includes at least two scene cameras (or at least two rear-facing cameras disposed on an opposite side of the handheld electronic device 110 as the display).

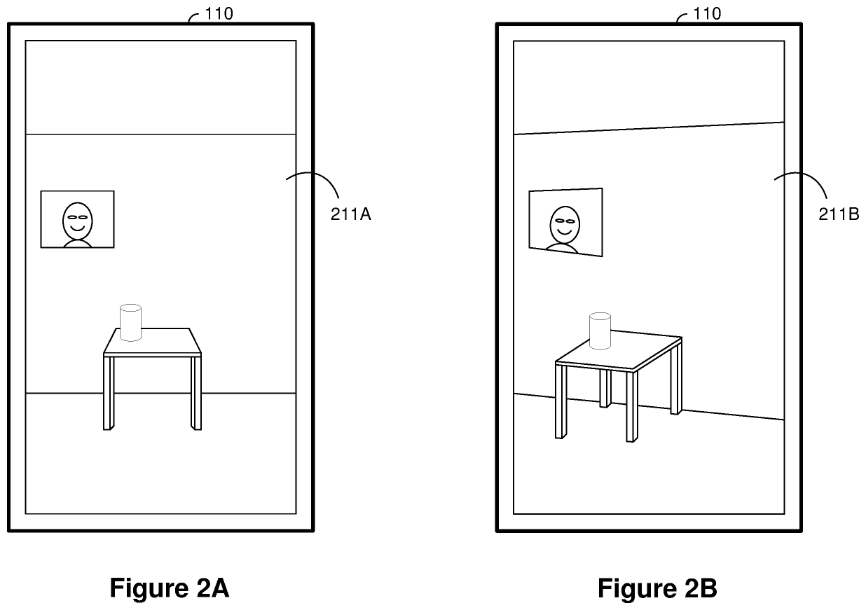

FIG. 2A illustrates the handheld electronic device 110 displaying a first image 211A of the physical environment 101 captured from a first perspective. FIG. 2B illustrates the handheld electronic device 110 displaying a second image 211B of the physical environment 101 captured from a second perspective different from the first perspective.

In various implementations, the first image 211A and the second image 211B are captured by the same camera at different times (e.g., by the same single scene camera at two different times when the handheld electronic device 110 is moved between the two different times). In various implementations, the first image 211A and the second image 211B are captured by different cameras at the same time (e.g., by two scene cameras).

Using a plurality of images of the physical environment 101 captured from a plurality of different perspectives, such as the first image 211A and the second image 211B, the handheld electronic device 110 generates a point cloud of the physical environment 101.

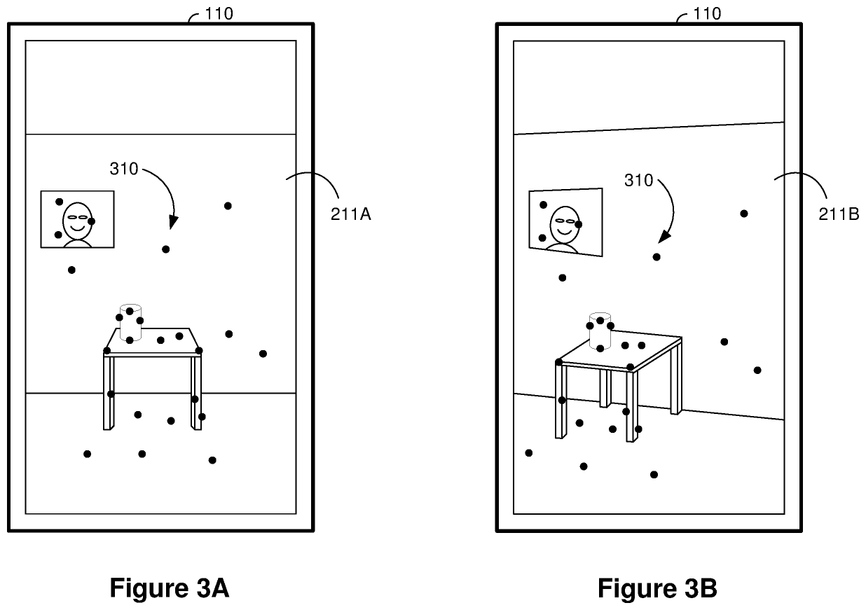

FIG. 3A illustrates the handheld electronic device 110 displaying the first image 211A overlaid with a representation of the point cloud 310. FIG. 3B illustrates the handheld electronic device 110 displaying the second image 211B overlaid with the representation of the point cloud 310.

The point cloud includes a plurality of points, wherein each of the plurality of points is associated with a set of coordinates in a three-dimensional space. For example, in various implementations, each point is associated with an x-coordinate, a y-coordinate, and a z-coordinate. In various implementations, each point in the point cloud corresponds to a feature in the physical environment 101, such as a surface of an object in the physical environment 101.

The handheld electronic device 110 spatially disambiguates the point cloud into a plurality of clusters. Accordingly, each of the clusters includes a subset of the points of the point cloud.

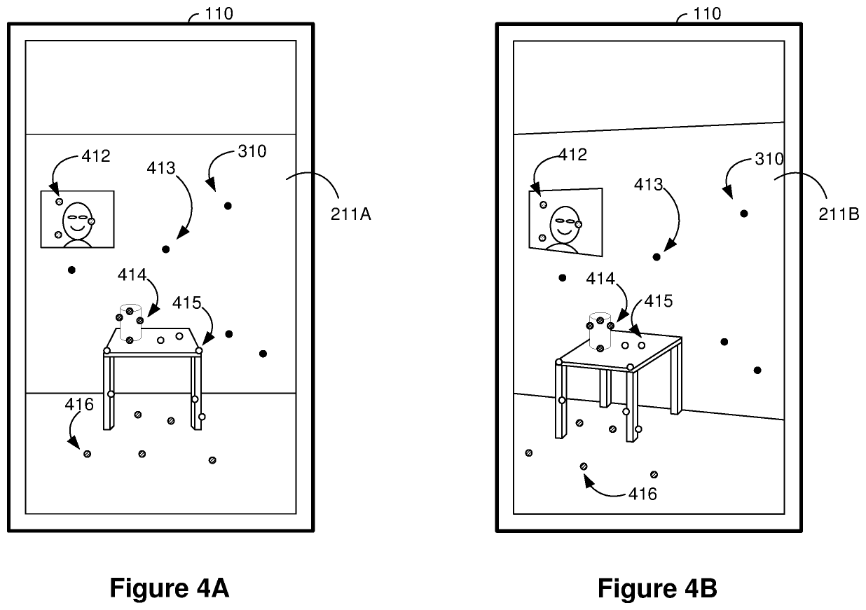

FIG. 4A illustrates the handheld electronic device 110 displaying the first image 211A overlaid with the representation of the point cloud 310 spatially disambiguated into a plurality of clusters 412-416. FIG. 4B illustrates the handheld electronic device 110 displaying the second image 211B overlaid with the representation of the point cloud 310 spatially disambiguated into the plurality of clusters 412-416. The representation of the point cloud 310 includes a first cluster 412 (shown in light gray), a second cluster 413 (shown in black), a third cluster 414 (shown in dark gray), a fourth cluster 415 (shown in white), and a fifth cluster 416 (shown in medium gray).

In various implementations, each of the plurality of clusters is assigned a unique cluster identifier. For example, the clusters may be assigned numbers, letters, or other unique labels.

In various implementations, for each cluster, the handheld electronic device 110 determines a semantic label. In various implementations, each cluster corresponds to an object in the physical environment. For example, in FIG. 4A and FIG. 4B, the first cluster 412 corresponds to the picture 102, the second cluster 413 corresponds to the wall 103, the third cluster 414 corresponds to the cylinder 104, the fourth cluster 415 corresponds to the table 105, and the fifth cluster 416 corresponds to the floor 106. In various implementations, the semantic label indicates an object type or identity of the object. In various implementations, the handheld electronic device 110 stores the semantic label in association with each point of the first cluster.

In various implementations, the handheld electronic device 110 determines multiple semantic labels for a cluster. In various implementations, the handheld electronic device 110 determines a series of hierarchical or layered semantic labels for the cluster. For example, the handheld electronic device 110 determines a number of semantic labels that identify the object represented by the cluster with increasing degrees of specificity. For example, the handheld electronic device 110 determines a first semantic label of “flat” for the cluster indicating that the cluster has one dimension substantially smaller than the other two. The handheld electronic device 110 then determines a second semantic label of “horizontal” indicating that the flat cluster is horizontal, e.g., like a floor or tabletop rather than vertical like a wall or picture. The handheld electronic device 110 then determines a third semantic label of “floor” indicating that that the flat, horizontal cluster is a floor rather than a table or ceiling. The handheld electronic device 110 then determines a fourth semantic label of “carpet” indicating that the floor is carpeted rather than a tile or hardwood floor.

In various implementations, the handheld electronic device 110 determines sub-labels associated with sub-clusters of a cluster. In various implementations, the handheld electronic device 110 spatially disambiguates portions of the cluster into a plurality of sub-clusters and determining a semantic sub-label based on the volumetric arrangement of the points of a particular sub-cluster of the cluster. For example, in various implementations, the handheld electronic device 110 determines a first semantic label of “table” for the cluster. After spatially disambiguating the table cluster into a plurality of sub-clusters, a first semantic sub-label of “tabletop” is determined for a first sub-cluster, whereas a second semantic sub-label of “leg” is determined for a second sub-cluster.

The handheld electronic device 110 can use the semantic labels in a variety of ways. For example, in various implementations, the handheld electronic device 110 can display a virtual object, such as a virtual ball, on the top of a cluster labeled as a “table”, but not on the top of a cluster labeled as a “floor”. In various implementations, the handheld electronic device 110 can display a virtual object, such as a virtual painting, over a cluster labeled as a “picture”, but not over a cluster labeled as a “television”.

In various implementations, the handheld electronic device 110 determines spatial relationships between the various clusters. For example, in various implementations, the handheld electronic device 110 determines a distance between the first cluster 412 and the fifth cluster 416. As another example, in various implementations, the handheld electronic device 110 determines a bearing angle between first cluster 412 and the fourth cluster 415. In various implementations, the handheld electronic device 110 stores the spatial relationships between a particular first cluster and the other first clusters as a spatial relationship vector in association with each point of the particular first cluster.

The handheld electronic device 110 can use the spatial relationship vectors in a variety of ways. For example, in various implementations, the handheld electronic device 110 can determine that objects in the physical environment are moving based on changes in the spatial relationship vectors. As another example, in various implementations, the handheld electronic device 110 can determine that a light emitting object is at a particular angle to another object and project light onto the other object from the particular angle. As another example, the handheld electronic device 110 can determine that an object is in contact with another object and simulate physics based on that contact.

In various implementations, the handheld electronic device 110 stores information regarding the point cloud as a point cloud data object.

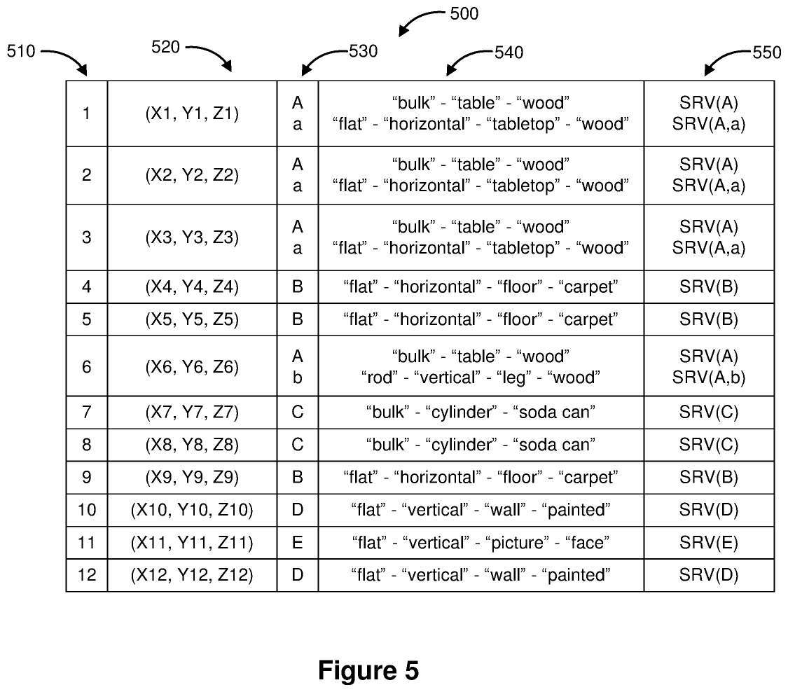

FIG. 5 illustrates a point cloud data object 500 in accordance with some implementations. The point cloud data object 500 includes a plurality of data elements (shown as rows in FIG. 5), wherein each data element is associated with a particular point of a point cloud. The data element for a particular point includes a point identifier field 510 that includes a point identifier of a particular point. As an example, the point identifier may be a unique number. The data element for the particular point includes a coordinate field 520 that includes a set of coordinates in a three-dimensional space of the particular point.

The data element for the particular point includes a cluster identifier field 530 that includes an identifier of the cluster into which the particular point is spatially disambiguated. As an example, the cluster identifier may be a letter or number. In various implementations, the cluster identifier field 530 also includes an identifier of a sub-cluster into which the particular point is spatially disambiguated.

The data element for the particular point includes a semantic label field 540 that includes one or more semantic labels for the cluster into which the particular point is spatially disambiguated. In various implementations, the semantic label field 540 also includes one or more semantic labels for the sub-cluster into which the particular point is spatially disambiguated.

The data element for the particular point includes a spatial relationship vector field 550 that includes a spatial relationship vector for the cluster into which the particular point is spatially disambiguated. In various implementations, the spatial relationship vector field 540 also includes a spatial relationship vector for the sub-cluster into which the particular point is spatially disambiguated.

The semantic labels and spatial relationships may be stored in association with the point cloud in other ways. For example, the point cloud may be stored as a set of cluster objects, each cluster object including a cluster identifier for a particular cluster, a semantic label of the particular cluster, a spatial relationship vector for the particular cluster, and a plurality of sets of coordinates corresponding to the plurality of points spatially disambiguated into the particular cluster.

In FIG. 5, a first point of the point cloud is assigned a point identifier of “1” (and may be referred to as “point 1”). Point 1 is associated with a first a set of coordinates in a three-dimensional space of (X1, Y1, Z1). Point 1 is spatially disambiguated into a cluster associated with a cluster identifier of “A” (which may be referred to as “cluster A”) and a sub-cluster associated with a sub-cluster identifier of “a” (which may be referred to as “sub-cluster A,a”). Point 1 is associated with a set of semantic labels for cluster A and is further associated with a set of semantic labels for sub-cluster A,a. Point 1 is associated with a spatial relationship vector of cluster A (SRV(A)) and a spatial relationship vector of sub-cluster A,a (SRV(A,a)). Points 2-12 are similarly associated with respective data.

Cluster A (and accordingly, point 1) is associated with a semantic label of “bulk” that indicates a shape of cluster A. In various implementations, each cluster is associated with a semantic label that indicates the shape of the cluster. In various implementations, each cluster is associated with a semantic label of “flat” indicating that the cluster has one dimension substantially smaller than the other two, “rod” indicating that the cluster has one dimension substantially larger than the other two, or “bulk” indicating that no dimension of the cluster is substantially smaller or larger than the others.

In various implementations, a cluster associated with a semantic label of “flat” or “rod” includes a semantic label indicating an orientation of the cluster (e.g., which dimension is substantially smaller or larger than the other two). For example, point 9 is associated with a semantic label of “flat” and a semantic label of “horizontal” indicating that the height dimension is smaller than the other two. As another example, point 10 is associated with a semantic label of “flat” and a semantic label of “vertical” indicating that the height dimension is not the smaller dimension. As another example, point 6 is associated with a semantic label of “rod” and a semantic label of “vertical” indicating that the height dimension is larger than the other two.

Cluster A is associated with a semantic label of “table” that indicates an object identity of cluster A. In various implementations, one or more clusters are respectively associated with one or more semantic labels that indicates an object identity of the cluster. For example, point 1 is associated with a semantic label of “table”, point 9 is associated with a semantic label of “floor”, and point 11 is associated with a semantic label of “picture”.

Cluster A is associated with a semantic label of “wood” that indicates an object property of the object type. In various implementations, one or more clusters are respectively associated with one or more semantic labels that indicates an object property of the object type of the cluster. In various implementations, a cluster associated with a semantic label indicating a particular object type also includes one or more of a set of semantic labels associated with the particular object type. For example, a cluster associated with a semantic label of “table” may include a semantic label of “wood”, “plastic”, “conference table”, “nightstand”, etc. As another example, a cluster associated with a semantic label of “floor” may include a semantic label of “carpet”, “tile”, “hardwood”, etc.

In various implementations, a cluster associated with a semantic label indicating a particular object property also includes one or more of a set of semantic labels associated with the particular object property that indicates a detail of the object property. For example, a cluster associated with a semantic label of “table” and a semantic label of “wood” may include a semantic label of “oak”, “mahogany”, “maple”, etc.

Subcluster A,a (and, accordingly, point 1) is associated with a set of semantic labels including “flat”, “horizontal”, “tabletop”, and “wood”.

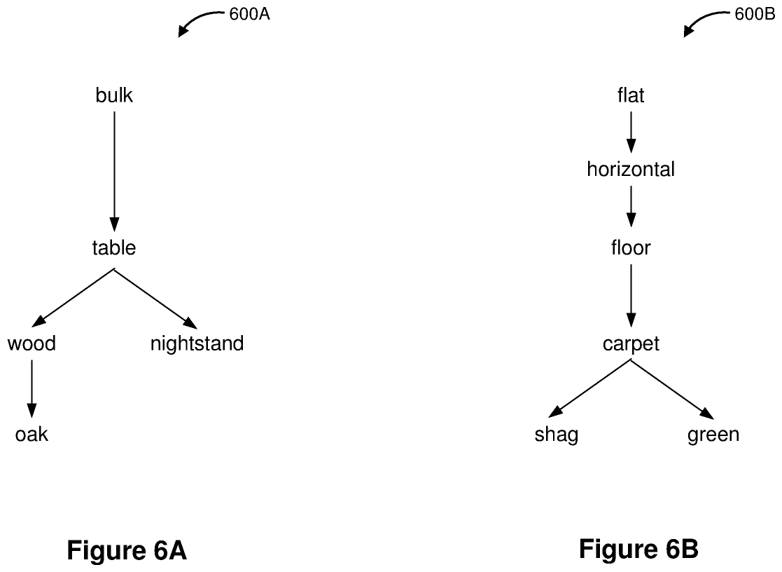

In various implementations, the semantic labels are stored as a hierarchical data object. FIG. 6A illustrates a first hierarchical data structure 600A for a set of semantic labels of a first cluster. FIG. 6B illustrates a second hierarchical data structure 600B for a set of semantic labels of a second cluster. At a shape layer, each hierarchical data structure includes a semantic label indicative of a shape of the cluster. The first hierarchical data structure 600A includes a semantic label of “bulk” at the shape layer and the second hierarchical data structure 600B includes a semantic label of “flat” at the shape layer.

At an orientation layer, the second hierarchical data structure 600B includes a semantic label of “horizontal”. The first hierarchical data structure 600A does not includes an orientation layer.

At an object identity layer, each hierarchical data structure includes a semantic label indicative of an object type. The first hierarchical data structure 600A includes a semantic label of “table” at the object identity layer and the second hierarchical data structure 600B includes a semantic label of “floor” at the object identity layer.

At an object property layer, each hierarchical data structure includes a semantic label indicative of an object property of the particular object type. The first hierarchical data structure 600A includes semantic label of “wood” and a semantic label of “nightstand” at the object property layer and the second hierarchical data structure 600B includes a semantic label of “carpet” at the object property layer.

At an object property detail layer, each hierarchical data structure includes a semantic label indicative of a detail of the particular object property. The first hierarchical data structure 600A includes semantic label of “oak” at the object property detail layer beneath the semantic label of “wood” and the second hierarchical data structure 600B includes a semantic label of “shag” and a semantic label of “green” at the object property detail layer beneath the semantic label of “carpet”.

As noted above, in FIG. 5, point 1 is associated with a spatial relationship vector of cluster A (SRV(A)) and a spatial relationship vector of sub-cluster A,a (SRV(A,a)). Points 2-12 are similarly associated with respective data.

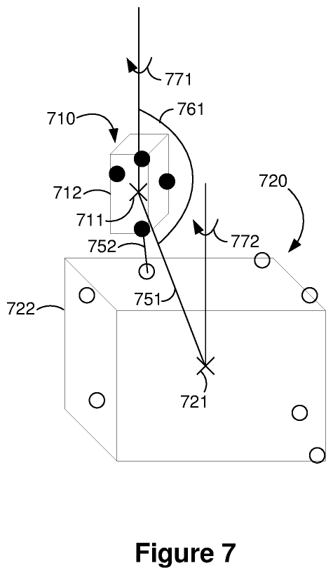

FIG. 7 illustrates spatial relationships between a first cluster of points 710 (shown in black) and a second cluster of points 720 (shown in white) in accordance with some implementations.

In various implementations, the spatial relationship vector includes a distance between the subset of the second plurality of points and the subset of the first plurality of points. In various implementations, the distance is a distance between the center of the subset of the second plurality of points and the center of the subset of the first plurality of points. For example, FIG. 7 illustrates the distance 751 between the center 711 of the first cluster of points 710 and the center 721 of the second cluster of points 720. In various implementations, the distance is a minimum distance between the closest points of the subset of the second plurality of points and the subset of the first plurality of points. For example, FIG. 7 illustrates the distance 752 between the closest points of the first cluster of point 710 and the second cluster of points 720. In various implementations, the spatial relationship vector indicates whether the subset of the second plurality of points contacts the subset of the first plurality of points.

In various implementations, the spatial relationship vector is a hierarchical data set including a hierarchy of spatial relationships. In various implementations, a first layer includes an indication of contact (or no contact), a second layer below the first layer includes an indication that a distance to another cluster is below a threshold (or above the threshold), and a third layer below the second layer indicates the distance.

In various implementations, the spatial relationship vector includes a bearing angle between the subset of the second plurality of points and the subset of the first plurality of points. In various implementations, the bearing angle is determined as the bearing from the center of the subset of the second plurality of points to the center of the subset of the first plurality of points. For example, FIG. 7 illustrates the bearing angle 761 between the center 711 of the first cluster of points 710 and the center 721 of the second cluster of points 720. Although only a single bearing angle is illustrated in FIG. 13, it is to be appreciated that in three dimensions, the bearing angle may have two components. In various implementations, the spatial relationship vector includes a bearing arc between the subset of the second plurality of points and the subset of the first plurality of points. In various implementations, the bearing arc includes the bearing angle and the number of degrees encompassed by the subset of the first plurality of points as viewed from the center of the subset of the second plurality of points.

In various implementations, a first layer includes a bearing angle and a second layer below the first layer includes a bearing arc.

In various implementations, the spatial relationship vector includes a relative orientation of the subset of the second plurality of points with respect to the subset of the first plurality of points. The relative orientation of the subset of the second plurality of points with respect to the subset of the first plurality of points indicates how much the subset of the second plurality of points is rotated with respect to the subset of the first plurality of points. For example, a cluster of points corresponding to a wall may be rotated 90 degrees with respect to a cluster of points generated by a floor (or 90 degrees about a different axis with respect to a cluster of points generated by another wall). FIG. 7 illustrates a first orientation 771 about a vertical axis of the first cluster of points 710 and a second orientation 772 about the vertical axis of the second cluster of points 720. In various implementations, the relative orientation is the difference between these two orientations. Although only a single orientation is illustrated in FIG. 13, it is to be appreciated that in three dimensions, the relative orientation may have two or three components.

In various implementations, the spatial relationship vector includes an element that is changed by a change in position or orientation of the subset of the second plurality of points with respect to the subset of the first plurality of points. For example, in various implementations, the element includes a distance, bearing, and orientation.

In various implementations, determining the spatial relationship vector includes determining a bounding box surrounding the subset of the second plurality of points and a bounding box surrounding the subset of the first plurality of points. For example, FIG. 7 illustrates a first bounding box 712 surrounding the first cluster of points 710 and a second bounding box 722 surrounding the second cluster of points 720. In various implementations, the center of the first cluster of points is determined as the center of the first bounding box and the center of the second cluster of points is determined as the center of the second bounding box. In various implementations, the distance between the first cluster of points and the second cluster of points is determined as the distance between the center of the first bounding box and the center of the second bounding box. In various implementations, the distance between the first cluster of points and the second cluster of points is determined as the minimum distance between the first bounding box and the second bounding box.

In various implementations, the orientation 771 of the first cluster of points 710 and the orientation 772 of the second cluster of points 720 are determined as the orientation of the first bounding box 712 and the orientation of the second bounding box 722.

In various implementations, the faces of the bounding boxes are given unique identifiers (e.g., the faces of each bounding box are labelled 1 through 6) to resolve ambiguities. The unique identifiers can be based on color of the points or the distribution of the points. Thus, if the second cluster of points rotates 90 degrees, the relative orientation is determined to have changed.

The point cloud data object 500 of FIG. 5 is one example of a three-dimensional scene model. In various implementations, different processes executed by the handheld electronic device 110 derive results from different portions of the three-dimensional scene model. One type of process executed by the handheld electronic device 110 is an objective-effectuator. In various implementations, the handheld electronic device 110 directs an XR representation of an objective-effectuator to perform one or more actions in order to effectuate (e.g., advance, satisfy, complete and/or achieve) one or more objectives (e.g., results and/or goals). In some implementations, the objective-effectuator is associated with a particular objective and the XR representation of the objective-effectuator performs actions that improve the likelihood of effectuating that particular objective. In some implementations, the XR representation of the objective-effectuator corresponds to an XR affordance. In some implementations, the XR representation of the objective-effectuator is referred to as an XR object.

In some implementations, an XR representation of the objective-effectuator performs a sequence of actions. In some implementations, the handheld electronic device 110 determines (e.g., generates and/or synthesizes) the actions for the objective-effectuator. In some implementations, the actions generated for the objective-effectuator are within a degree of similarity to actions that a corresponding entity (e.g., a character, an equipment and/or a thing) performs as described in fictional material or as exists in a physical environment. For example, in some implementations, an XR representation of an objective-effectuator that corresponds to a fictional action figure performs the action of flying in an XR environment because the corresponding fictional action figure flies as described in the fictional material. Similarly, in some implementations, an XR representation of an objective-effectuator that corresponds to a physical drone performs the action of hovering in an XR environment because the corresponding physical drone hovers in a physical environment. In some implementations, the handheld electronic device 110 obtains the actions for the objective-effectuator. For example, in some implementations, the handheld electronic device 110 receives the actions for the objective-effectuator from a separate device (e.g., a remote server) that determines the actions.

In some implementations, an objective-effectuator corresponding to a character is referred to as a character objective-effectuator, an objective of the character objective-effectuator is referred to as a character objective, and an XR representation of the character objective-effectuator is referred to as an XR character. In some implementations, the XR character performs actions in order to effectuate the character objective.

In some implementations, an objective-effectuator corresponding to equipment (e.g., a rope for climbing, an airplane for flying, a pair of scissors for cutting) is referred to as an equipment objective-effectuator, an objective of the equipment objective-effectuator is referred to as an equipment objective, and an XR representation of the equipment objective-effectuator is referred to as an XR equipment. In some implementations, the XR equipment performs actions in order to effectuate the equipment objective.

In some implementations, an objective-effectuator corresponding to an environmental feature (e.g., weather pattern, features of nature and/or gravity level) is referred to as an environmental objective-effectuator, and an objective of the environmental objective-effectuator is referred to as an environmental objective. In some implementations, the environmental objective-effectuator configures an environmental feature of the XR environment in order to effectuate the environmental objective.

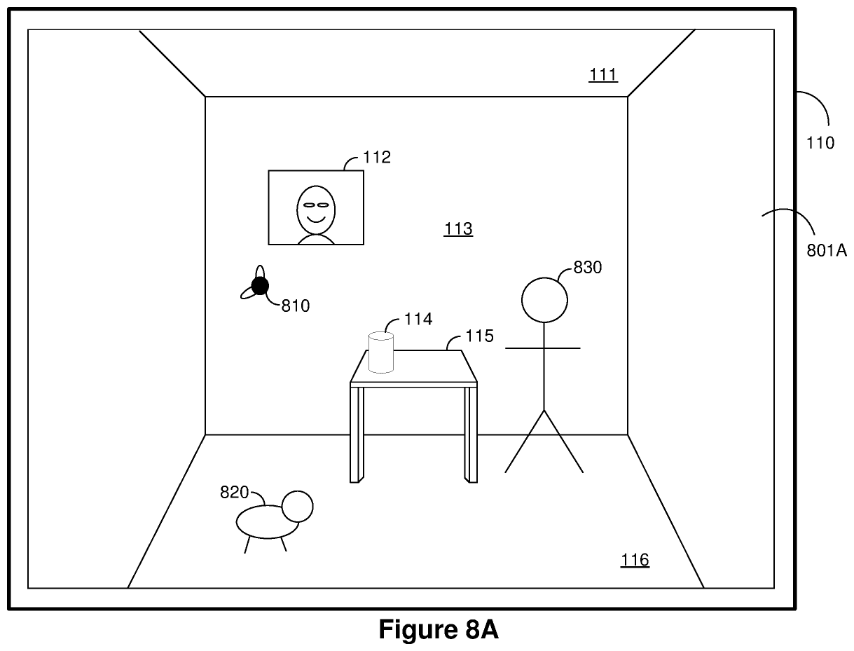

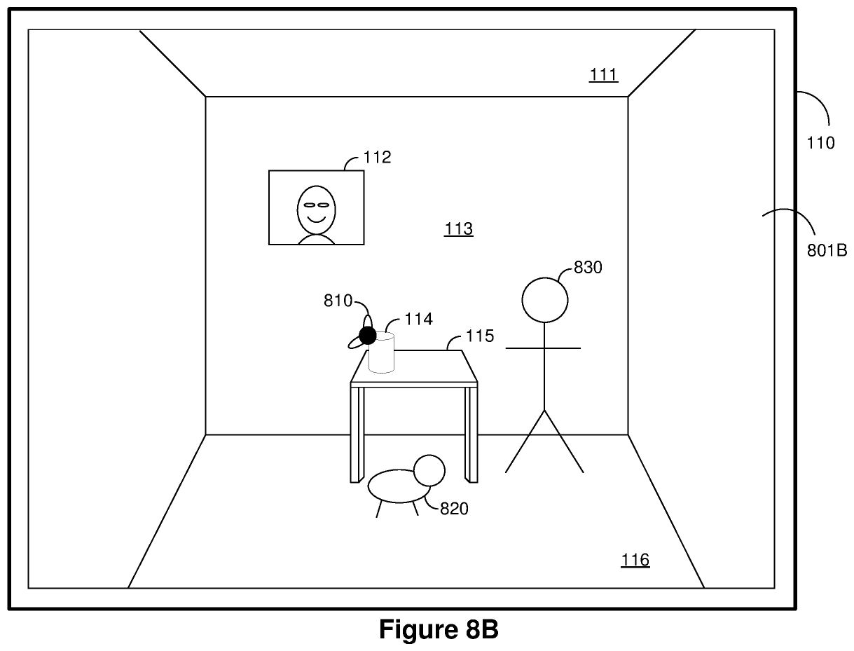

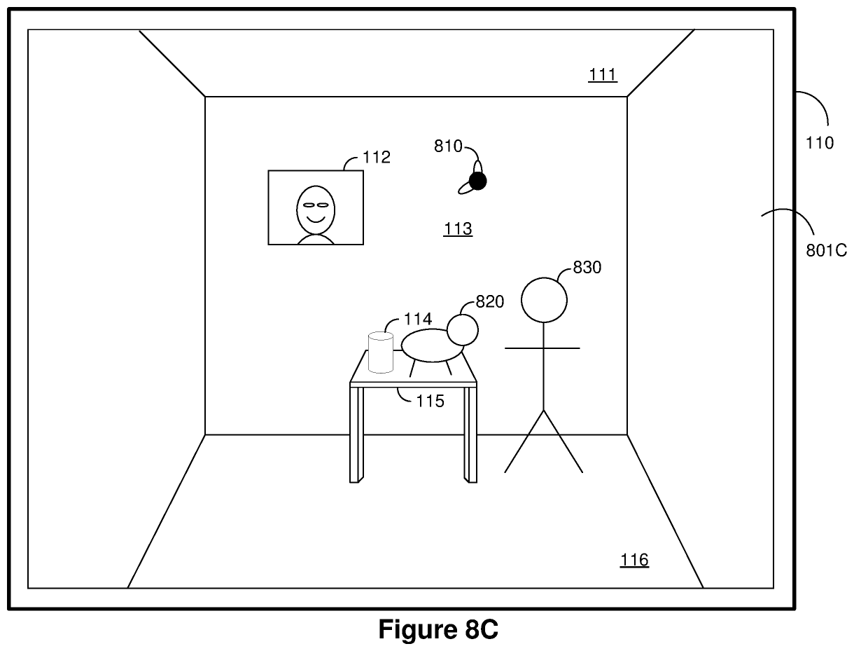

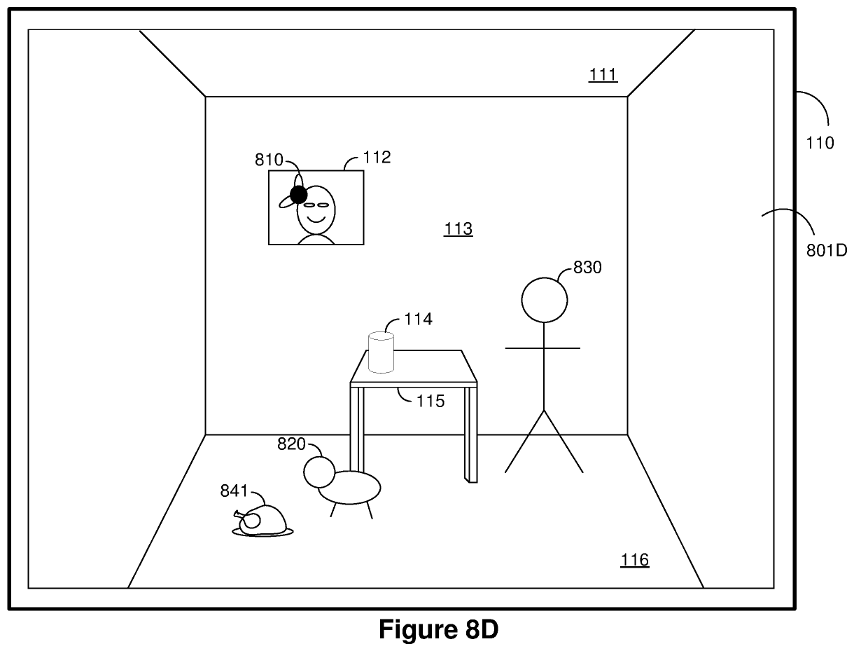

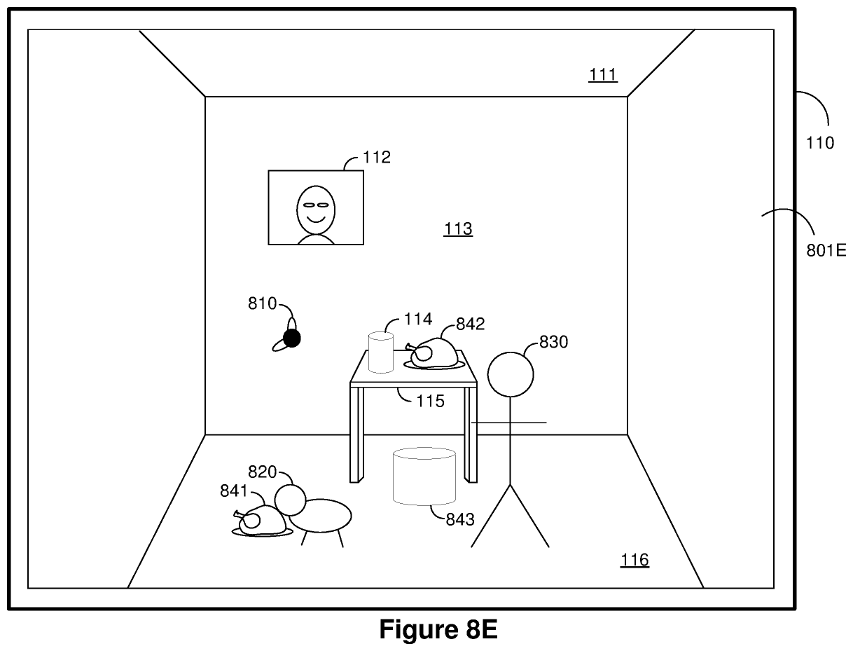

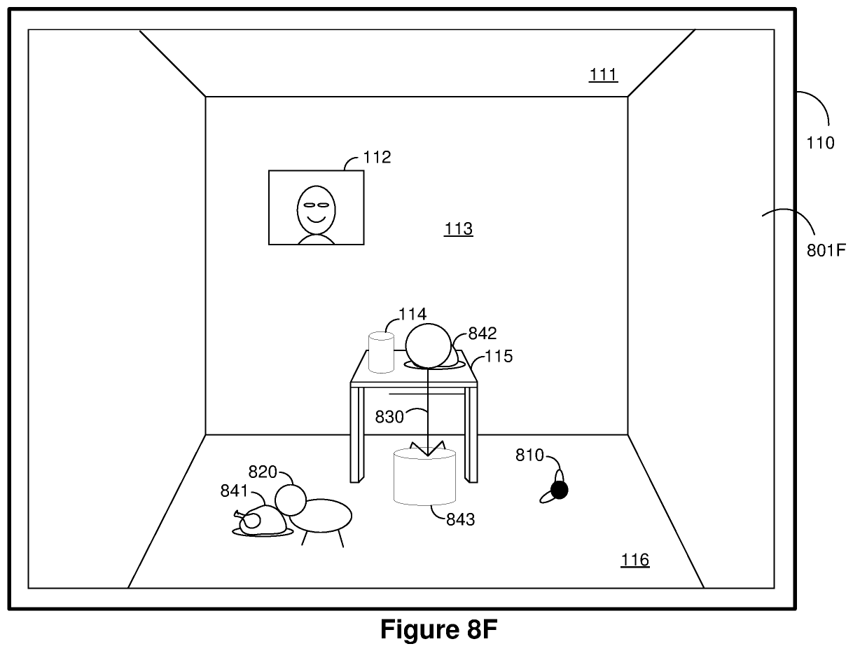

FIG. 8A illustrates the handheld electronic device 110 displaying a first image 801A of the physical environment 101 during a first time period. The first image 801A includes a representation of the physical environment 111 including a representation of the picture 112 hanging on a representation of the wall 113, a representation of the table 115 on a representation of the floor 116, and a representation of the cylinder 114 on the representation of the table 115.

The first image 801A includes a representation of an objective-effectuator corresponding to a fly (referred to as the XR fly 810). The first image 801A includes a representation of an objective-effectuator corresponding to a cat (referred to as the XR cat 820). The first image 801A includes a representation of an objective-effectuator corresponding to a person (referred to as the XR person 830).

The XR fly 810 is associated with an objective to explore the physical environment 101. The XR fly 810 flies randomly around the physical environment, but after an amount of time, must land to rest. The XR cat 820 is associated with an objective to obtain the attention of the XR person 830. The XR cat 820 attempts to get closer to the XR person 830. The XR person 830 is associated with an objective to sit down and an objective to eat food.

FIG. 8B illustrates the handheld electronic device 110 displaying a second image 801B of the physical environment 101 during a second time period. To achieve the objective to explore the physical environment 101, the XR fly 810 has flown around randomly, but must land to rest. Thus, in FIG. 8B, as compared to FIG. 8A, the XR fly 810 is displayed as landed on the representation of the cylinder 114. To achieve the objective to obtain the attention of the XR person 830, the XR cat 820 has walked closer to the XR person 830. Thus, in FIG. 8B, as compared to FIG. 8A, the XR cat 820 is displayed closer to the XR person 830.

Although attempting to achieve the objective to sit down and the objective to eat food, the XR person 830 did not identify, in the XR environment, an appropriate place to sit or appropriate food to eat. Thus, in FIG. 8B, as compared to FIG. 8A, the XR person 830 is displayed in the same location.

FIG. 8C illustrates the handheld electronic device 110 displaying a third image 801C of the physical environment 101 during a third time period. To achieve the objective to explore the physical environment 101, the XR fly 810 flies around randomly. Thus, in FIG. 8C, as compared to FIG. 8B, the XR fly 810 is displayed flying around the representation of the physical environment 111. To achieve the objective to obtain the attention of the XR person 830, the XR cat 820 has jumped on the representation of the table 115 to be closer to the XR person 830. Thus, in FIG. 8C, as compared to FIG. 8B, the XR cat 820 is displayed closer to the XR person 830 on top of the representation of the table 115.

Although attempting to achieve the objective to sit down and the objective to eat food, the XR person 830 did not identify, in the XR environment, an appropriate place to sit or appropriate food to eat. Thus, in FIG. 8C, as compared to FIG. 8B, the XR person 830 is displayed in the same location.

FIG. 8D illustrates the handheld electronic device 110 displaying a fourth image 801D of the physical environment 101 during a fourth time period. To achieve the objective to explore the physical environment 101, the XR fly 810 has flown around randomly, but must land to rest. Thus, in FIG. 8D, as compared to FIG. 8C, the XR fly 810 is displayed on the representation of the picture 112. After achieving the objective to obtain the attention of the XR person 830, the XR cat 820 is associated with an objective to eat food. In FIG. 8D, the XR environment includes first XR food 841 on the representation of the floor 116. Thus, in FIG. 8D, as compared to FIG. 8C, the XR cat 820 is displayed closer to the first XR food 841.

Although attempting to achieve the objective to sit down and the objective to eat food, the XR person 830 did not identify, in the XR environment, an appropriate place to sit or appropriate food to eat. In particular the XR person 830 determines that the first XR food 841, being on the representation of the floor 116, is not appropriate food to eat. Thus, in FIG. 8D, as compared to FIG. 8C, the XR person 830 is displayed in the same location.

FIG. 8E illustrates the handheld electronic device 110 displaying a fifth image 801E of the physical environment 101 during a fifth time period. To achieve the objective to explore the physical environment 101, the XR fly 810 flies around randomly. Thus, in FIG. 8E, as compared to FIG. 8D, the XR fly 810 is displayed flying around the representation of the physical environment 111. To achieve the objective to eat food, the XR cat 820 has moved closer to the first XR food 841 and begun to eat it. Thus, in FIG. 8E, as compared to FIG. 8D, the XR cat 820 is displayed eating the first XR food 841.

FIG. 8E includes second XR food 842 and an XR stool 843. To achieve the objective to sit down and the objective to eat food, the XR person 830 moves closer to the XR stool 843. Thus, in FIG. 8E, as compared to FIG. 8D, the XR person 830 is displayed closer to the XR stool 843.

FIG. 8F illustrates the handheld electronic device 110 displaying a sixth image 801F of the physical environment 101 during a sixth time period. To achieve the objective to explore the physical environment 101, the XR fly 810 has flown around randomly, but must land to rest. Thus, in FIG. 8F, as compared to FIG. 8E, the XR fly 810 is displayed on the representation of the floor 116. To achieve the objective to eat food, the XR cat 820 continues to eat the first XR food 841. Thus, in FIG. 8F, as compared to FIG. 8E, the XR cat 820 continues to be displayed eating the first XR food 841. To achieve the objective to sit down and the objective to eat food, the XR person 830 sits on the XR stool 843 and eats the second XR food 842. Thus, in FIG. 8F, as compared to FIG. 8E, the XR person 830 is displayed sitting on the XR stool 843 eating the second XR food 842.

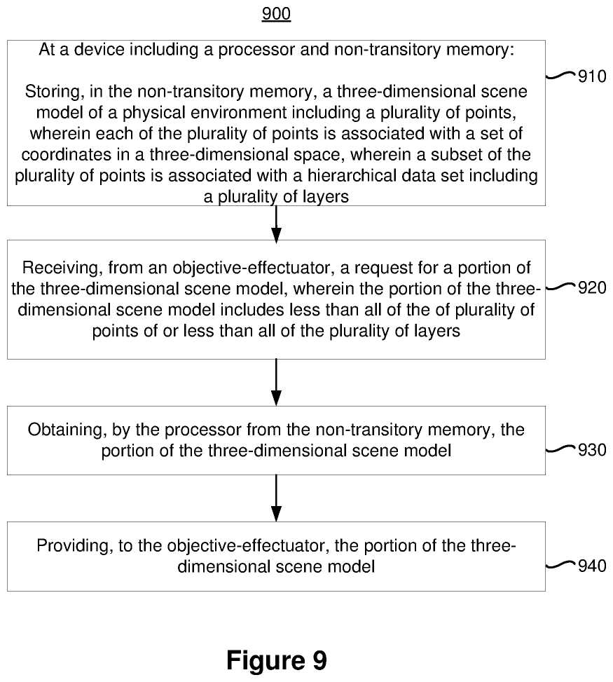

FIG. 9 is a flowchart representation of a method 900 of providing a portion of a three-dimensional scene model in accordance with some implementations. In various implementations, the method 900 is performed by a device with a processor and non-transitory memory. In some implementations, the method 900 is performed by processing logic, including hardware, firmware, software, or a combination thereof. In some implementations, the method 900 is performed by a processor executing instructions (e.g., code) stored in a non-transitory computer-readable medium (e.g., a memory).

The method 900 begins, in block 910, with the device storing, in the non-transitory memory, a three-dimensional scene model of a physical environment including a plurality of points, wherein each of the plurality of points is associated with a set of coordinates in a three-dimensional space, wherein a subset of the plurality of points is associated with a hierarchical data set including a plurality of layers.

In various implementations, the three-dimensional scene model includes the plurality of points as vertices of one or more mesh-based object models, wherein the one or more mesh-based object models include one or more edges between the vertices. In various implementations, the mesh-based object models further include one or more faces surrounded by edges, one or more textures associated with the faces, and/or a semantic label, object/cluster identifier, physics data or other information associated with the mesh-based object model.

The plurality of points, alone or as the vertices of mesh-based object models, is a point cloud. Accordingly, in various implementations, storing the first three-dimensional scene model includes obtaining a point cloud.

In various implementations, obtaining the point cloud includes obtaining a plurality of images of the physical environment from a plurality of different perspectives and generating the point cloud based on the plurality of images of the physical environment. For example, in various implementations, the device detects the same feature in two or more images of the physical environment and using perspective transform geometry, determines the sets of coordinates in the three-dimensional space of the feature. In various implementations, the plurality of images of the physical environment is captured by the same camera at different times (e.g., by the same single scene camera of the device at different times when the device is moved between the times). In various implementations, the plurality of images is captured by different cameras at the same time (e.g., by multiple scene cameras of the device).

In various implementations, obtaining the point cloud includes obtaining an image of a physical environment, obtaining a depth map of the image of the physical environment, and generating the point cloud based on the image of the physical environment and the depth map of the image of the physical environment. In various implementations, the image is captured by a scene camera of the device and the depth map of the image of the physical environment is generated by a depth sensor of the device.

In various implementations, obtaining the point cloud includes using a 3D scanner to generate the point cloud.

In various implementations, each point in the point cloud is associated with additional data. In various implementations, each point in the point cloud is associated with a color. In various implementations, each point in the point cloud is associated with a color-variation indicating how the point changes color over time. As an example, such information may be useful in discriminating between a semantic label of a “picture” or a “television”. In various implementations, each point in the point cloud is associated with a confidence indicating a probability that the set of coordinates in the three-dimensional space of the point is the true location of the corresponding surface of the object in the physical environment.

In various implementations, obtaining the point cloud includes spatially disambiguating portions of the plurality of points into a plurality of clusters including the subset of the plurality of points associated with the hierarchical data set. Each cluster includes a subset of the plurality of points of the point cloud and is assigned a unique cluster identifier. In various implementations, particular points of the plurality of points (e.g., those designated as noise) are not included in any of the plurality of clusters.

Various point cloud clustering algorithms can be used to spatially disambiguate the point cloud. In various implementations, spatially disambiguating portions of the plurality of points into the plurality of clusters includes performing plane model segmentation. Accordingly, certain clusters of the plurality of clusters correspond to sets of points of the point cloud that lie in the same plane. In various implementations, spatially disambiguating portions of the plurality of points into the plurality of clusters includes performing Euclidean cluster extraction.

In various implementations, storing the first three-dimensional scene model includes obtaining the hierarchical data set. In various implementations, the hierarchical data set includes a hierarchy of semantic labels. Accordingly, in various implementations, storing the first three-dimensional scene model includes determining one or more semantic labels for the subset of the plurality of points.

In various implementations, the device determines a semantic label by comparing dimensions of the subset of the plurality of points. For example, in various implementations, each cluster is associated with a semantic label of “flat” indicating that the cluster (or a bounding box surrounding the cluster) has one dimension substantially smaller than the other two, “rod” indicating that the cluster (or a bounding box surrounding the cluster) has one dimension substantially larger than the other two, or “bulk” indicating that no dimension of the cluster (or a bounding box surrounding the cluster) is substantially smaller or larger than the others.

In various implementations, the device determines a semantic label with a neural network. In particular, the device applies a neural network to the sets of coordinates in the three-dimensional space of the points of the subset of the plurality of points to generate a semantic label.

In various implementations, the neural network includes an interconnected group of nodes. In various implementation, each node includes an artificial neuron that implements a mathematical function in which each input value is weighted according to a set of weights and the sum of the weighted inputs is passed through an activation function, typically a non-linear function such as a sigmoid, piecewise linear function, or step function, to produce an output value. In various implementations, the neural network is trained on training data to set the weights.

In various implementations, the neural network includes a deep learning neural network. Accordingly, in some implementations, the neural network includes a plurality of layers (of nodes) between an input layer (of nodes) and an output layer (of nodes). In various implementations, the neural network receives, as inputs, the sets of coordinates in the three-dimensional space of the points of the subset of the first plurality of points. In various implementations, the neural network provides, as an output, a semantic label for the subset.

As noted above, in various implementations, each point is associated with additional data. In various implementations, the additional data is also provided as an input to the neural network. For example, in various implementations, the color or color variation of each point of the subset is provided to the neural network. In various implementations, the confidence of each point of the cluster is provided to the neural network.

In various implementations, the neural network is trained for a variety of object types. For each object type, training data in the form of point clouds of objects of the object type is provided. More particularly, training data in the form of the sets of coordinates in the three-dimensional space of the points of point cloud are provided. Thus, the neural network is trained with many different point clouds of different tables to train the neural network to classify clusters as a “table”. Similarly, the neural network is trained with many different point clouds of different chairs to train the neural network to classify clusters as a “chair”.

In various implementations, the neural network includes a plurality of neural network detectors, each trained for a different object type. Each neural network detector, trained on point clouds of objects of the particular object type, provides, as an output, a probability that a particular subset corresponds to the particular object type in response to receiving the sets of coordinates in the three-dimensional space of the points of the particular subset. Thus, in response to receiving the sets of coordinates in the three-dimensional space of the points of a particular subset, a neural network detector for tables may output a 0.9, a neural network detector for chairs may output a 0.5, and a neural network detector for cylinders may output a 0.2. The semantic label is determined based on the greatest output.

In various implementations, the hierarchical data set includes a hierarchy of spatial relationships. Accordingly, in various implementations, storing the first three-dimensional scene model includes determining one or more spatial relationships for the subset of the plurality of points.

The method 900 continues, in block 920, with the device receiving, from an objective-effectuator, a request for a portion of the three-dimensional scene model, wherein the portion of the three-dimensional scene model includes less than all of the plurality of points or less than all of the plurality of layers.

The method 900 continues, in block 930, with the device obtaining, by the processor from the non-transitory memory, the portion of the three-dimensional scene model. The method 900 continues, in block 940, with the device providing, to the objective-effectuator, the portion of the three-dimensional scene model. In various implementations, the device obtains and provides the portion of the three-dimensional scene model without obtaining or providing the remainder of the three-dimensional scene model. Reducing the amount of a data loaded from the non-transitory memory and/or transmitted via a communications interface provides a number of technological benefits, including a reduction of power used by the device, a reduction of bandwidth used by the device, and a reduction in latency in rendering XR content.

In various implementations, the device executes, using the processor, the objective-effectuator and generates the request. In various implementations, the device executes, using a different processor, the objective-effectuator and transmits the request to the processor. In various implementations, another device (either within the physical environment or remote to the physical environment) executes the objective-effectuator and transmits the request to the device. Thus, in various implementations, the device includes a communications interface and receiving the request for the portion of the three-dimensional scene model includes receiving the request via the communications interface. Similarly, in various implementations, providing the portion of three-dimensional scene model includes transmitting the portion via the communications interface.

In various implementations, the request for the portion of the three-dimensional scene model includes a request for a portion of the three-dimensional scene model within a distance of a representation of the objective-effectuator. For example, with respect to FIGS. 8A-8F, because a real fly can only see a short distance, the XR fly 810 (which is located at a set of three-dimensional coordinates in the space) requests a portion of the three-dimensional scene model within a fixed distance (e.g., 1 meter) from the XR fly 810. In various implementations, the request indicates a location (e.g., a set of three-dimensional coordinates) and a distance (e.g., 1 meter). In response, the device provides a portion of the three-dimensional scene model within the distance of the location (or, the entirety of object models having any portion within the distance of the location). In contrast, because a real cat can see the entirety of a room, the XR cat 820 requests the entire spatial portion of the three-dimensional scene model.

In various implementations, the request for the portion of the three-dimensional scene model includes a request for a spatially down-sampled version of the three-dimensional scene model. For example, with respect to FIGS. 8A-8F, because a real fly can only see with a low resolution, the XR fly 810 requests a spatially down-sampled version of the three-dimensional scene model. In various implementations, the request includes a down-sampling factor or a maximum resolution. In response, the device provides a version of the three-dimensional scene model down-sampled by the down-sampling factor or with a resolution less than the maximum resolution. In contrast, because a real cat can see fine details, the XR cat 820 requests the entire spatial portion of the three-dimensional scene model.

In various implementations, the hierarchical data set includes a hierarchy of semantic labels and the request for the portion of the three-dimensional scene model includes a request for less than all the layers of the hierarchy of semantic labels. For example, with respect to FIGS. 8A-8F, because a real fly will land on any object, the XR fly 810 requests the three-dimensional scene model without semantic label information. In contrast, because a real cat will walk, sit, or stand on any flat horizontal object (e.g., a “floor” as in FIG. 8A or a “table” as in FIG. 8C), the XR cat 820 requests the three-dimensional scene model with semantic label information up to a orientation layer (e.g., the shape layer and the orientation layer), but does not request the semantic label orientation to an object identity layer. In further contrast, because a real person will only stand on the floor or sit in a chair, the XR person 830 requests the three-dimensional scene model with semantic label information up to an object identity layer. In various implementations, the XR person 830 (in order to achieve an objective) will only sit in certain kinds of chairs or only eat certain kinds of food and may request the three-dimensional scene model with semantic label information up to an object property layer or an object property detail layer.

In various implementations, the hierarchical data set includes a hierarchy of spatial relationships and the request for the portion of the three-dimensional scene model includes a request for less than all the layers of the hierarchy of spatial relationships. For example, with respect to FIGS. 8A-8F, because a real cat will eat food off the floor, the XR cat 820 does not request spatial relationship information indicating that the first XR food 841 is in contact with the representation of the floor 116. In contrast, because a real person will not eat food of the floor, but only off a table, the XR person 830 requests spatial relationship information indicating that the first XR food 841 is in contact with the representation of the floor 116 and that the second XR food 842 is in contact with the representation of the table 115. As another example, because a real person will sit in a chair near enough to food to eat it, the XR person 830 requests spatial relationship information indicating the distance between the XR stool 843 and the representation of the table 115 and/or the second XR food 842.

As illustrated by the examples above, in various implementations, a first objective-effectuator requests a portion of the three-dimensional scene model including a first subset of the plurality of points or the plurality of layers and a second objective-effectuator requests a portion of the three-dimensional scene model including the first subset and a second subset of the plurality of points or the plurality of layers. Thus, the second objective-effectuator requests more detailed information of the three-dimensional scene model.

In various implementations, the request for the portion of the three-dimensional scene model is based on a current objective of the objective-effectuator. For example, with respect to FIGS. 8A-8F, when the XR cat 820 has an objective of obtaining the attention of the XR person 830, the XR cat 820 does not request semantic label information to an object identity layer. However, when the XR cat 820 has an objective of eating food, the XR cat 820 requests semantic label information to an object identity layer (e.g., to identify “food” to eat instead of a “table” to eat).

In various implementations, request for the portion of the three-dimensional scene model is based on one or more inherent attributes of the objective-effectuator. For example, with respect to FIGS. 8A-8F, the XR fly 810 can only see a particular distance at a maximum resolution and requests limited spatial information of the three-dimensional scene model. As another example, the XR fly 810 has limited intellectual capabilities and cannot distinguish between a “table” and a “wall” and does not request semantic label information to an object identity layer. Thus, in various implementations, the inherent attributes include a size, intelligence, or capability of the objective-effectuator.

In various implementations, the request for the portion of the three-dimensional scene model is based on current XR application including a representation of the objective-effectuator. For example, in a first XR application, an XR person is autonomous and does not respond to user commands Thus, the XR person requests more detailed information of the three-dimensional scene model. In a second XR application, the XR person is controlled by a user and does not request detailed information of the three-dimensional scene model, relying on user commands to perform whatever functions are commanded.

In various implementations, the device includes a display and the method 900 includes receiving, from the objective-effectuator, an action based on the portion of the three-dimensional scene model and displaying, on the display, a representation of the objective-effectuator performing the action. For example, with respect to FIGS. 8A-8F, the handheld electronic device 110 displays the XR fly 810 flying around and landing on various objects, displays the XR cat 820 moving towards the XR person 830 and eating the first XR food 841, and displays the XR person 830 sitting on the XR stool 843 and eating the second XR food 842.

Whereas FIG. 9 describes a method of loading portions of a three-dimensional scene model based on the attributes of an objective-effectuator, a similar method includes generating only a portion of a three-dimensional scene model based on the attributes of an objective-effectuator. For example, in various implementations, the device receives, from an objective-effectuator, a request for a three-dimensional scene model of a particular size or resolution and the device generates the three-dimensional scene model of the particular size or resolution. As another example, the device receives, from an objective-effectuator, a request for a three-dimensional scene model having particular hierarchical layers and the device generates the three-dimensional scene model having the particular hierarchical layers without generating lower layers.

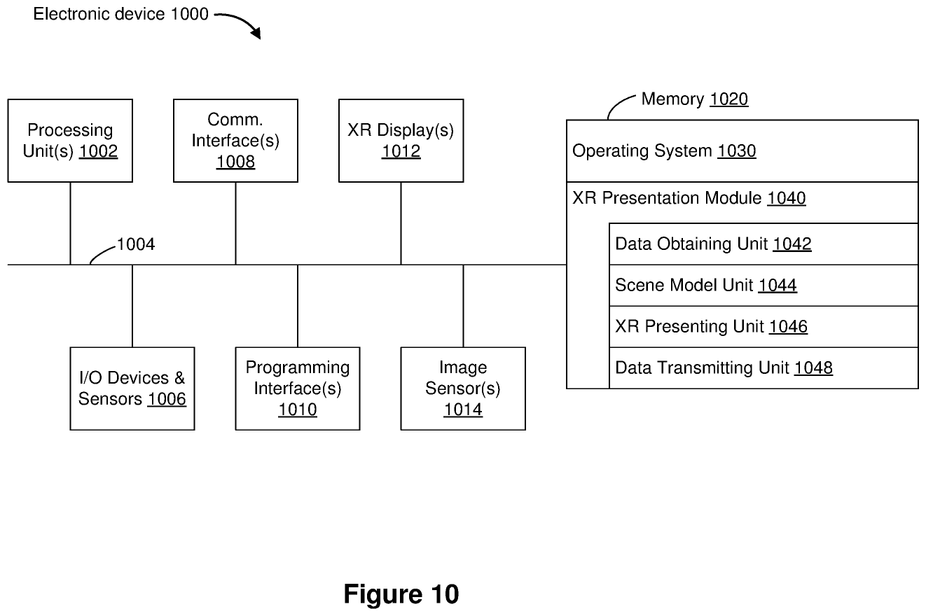

FIG. 10 is a block diagram of an electronic device 1000 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 1000 includes one or more processing units 1002, one or more input/output (I/O) devices and sensors 1006, one or more communication interfaces 1008, one or more programming interfaces 1010, one or more XR displays 1012, one or more image sensors 1014, a memory 1020, and one or more communication buses 1004 for interconnecting these and various other components. In various implementations, the one or more processing units 1002 includes one or more of a microprocessor, ASIC, FPGA, GPU, CPU, or processing core. In various implementations, the one or more communication interfaces 1008 includes a USB interface, a cellular interface, or a short-range interface.

In some implementations, the one or more communication buses 1004 include circuitry that interconnects and controls communications between system components. In some implementations, the one or more I/O devices and sensors 1006 include an inertial measurement unit (IMU), which may include an accelerometer and/or a gyroscope. In various implementations, the one or more I/O devices and sensors 1006 includes a thermometer, a biometric sensor (e.g., blood pressure monitor, heart rate monitor, blood oxygen sensor, blood glucose sensor, etc.), a microphone, a speaker, or a depth sensor.

In some implementations, the one or more XR displays 1012 are configured to present XR content to the user. In various implementations, the electronic device 1000 includes an XR display for each eye of the user.

In various implementations, the one or more XR displays 1012 are video passthrough displays which display at least a portion of a physical environment as an image captured by a scene camera. In various implementations, the one or more XR displays 1012 are optical see-through displays which are at least partially transparent and pass light emitted by or reflected off the physical environment.

In some implementations, the one or more image sensors 1014 are configured to obtain image data that corresponds to at least a portion of the face of the user that includes the eyes of the user. In various implementations, such an image sensor is referred to as an eye-tracking camera. In some implementations, the one or more image sensors 1014 are configured to obtain image data that corresponds to the physical environment as would be viewed by the user if the electronic device 1000 was not present. In various implementations, such an image sensor is referred to as a scene camera. The one or more optional image sensors 1014 can include an RGB camera (e.g., with a complimentary metal-oxide-semiconductor (CMOS) image sensor or a charge-coupled device (CCD) image sensor), an infrared (IR) camera, an event-based camera, or any other sensor for obtaining image data.

In various implementations, the memory 1020 includes high-speed random-access memory. In various implementations, the memory 1020 includes non-volatile memory, such as a magnetic disk storage device, an optical disk storage device, or a flash memory device. The memory 1020 optionally includes one or more storage devices remotely located from the one or more processing units 1002. The memory 1020 comprises a non-transitory computer readable storage medium. In some implementations, the memory 1020 or the non-transitory computer readable storage medium of the memory 1020 stores the following programs, modules and data structures, or a subset thereof including an optional operating system 1030 and an XR presentation module 1040.

The operating system 1030 includes procedures for handling various basic system services and for performing hardware dependent tasks. In some implementations, the XR presentation module 1040 is configured to present XR content to the user via the one or more XR displays 1012. To that end, in various implementations, the XR presentation module 1040 includes a data obtaining unit 1042, a scene model unit 1044, an XR presenting unit 1046, and a data transmitting unit 1048.

In some implementations, the data obtaining unit 1042 is configured to obtain data (e.g., presentation data, interaction data, sensor data, location data, etc.). The data may be obtained from the one or more processing units 1002 or another electronic device. For example, in various implementations, the data obtaining unit 1042 obtains (and stores in the memory 1020) a three-dimensional scene model of a physical environment (including, in various implementations, a point cloud). To that end, in various implementations, the data obtaining unit 1042 includes instructions and/or logic therefor, and heuristics and metadata therefor.

In some implementations, the scene model unit 1044 is configured to respond to requests for a portion of the three-dimensional scene model. To that end, in various implementations, the scene model unit 1044 includes instructions and/or logic therefor, and heuristics and metadata therefor.

In some implementations, the XR presenting unit 1046 is configured to present XR content via the one or more XR displays 1012. To that end, in various implementations, the XR presenting unit 1046 includes instructions and/or logic therefor, and heuristics and metadata therefor.

In some implementations, the data transmitting unit 1048 is configured to transmit data (e.g., presentation data, location data, etc.) to the one or more processing units 1002, the memory 1020, or another electronic device. To that end, in various implementations, the data transmitting unit 1048 includes instructions and/or logic therefor, and heuristics and metadata therefor.

Although the data obtaining unit 1042, the scene model unit 1044, the XR presenting unit 1046, and the data transmitting unit 1048 are shown as residing on a single electronic device 1000, it should be understood that in other implementations, any combination of the data obtaining unit 1042, the scene model unit 1044, the XR presenting unit 1046, and the data transmitting unit 1048 may be located in separate computing devices.

While various aspects of implementations within the scope of the appended claims are described above, it should be apparent that the various features of implementations described above may be embodied in a wide variety of forms and that any specific structure and/or function described above is merely illustrative. The terminology used herein is for the purpose of describing particular implementations only and is not intended to be limiting of the claims. Based on the present disclosure one skilled in the art should appreciate that an aspect described herein may be implemented independently of any other aspects and that two or more of these aspects may be combined in various ways. It will also be understood that, although the terms “first,” “second,” etc. may be used herein to describe various elements, these elements should not be limited by these terms. These terms are only used to distinguish one element from another. For example, a first object could be termed a second object, and, similarly, a second object could be termed a first object, which changing the meaning of the description, so long as all occurrences of the “first object” are renamed consistently and all occurrences of the “second object” are renamed consistently. The first object and the second object are both nodes, but they are, in various implementations, not the same object.

What is claimed is:

1. A method comprising:
at a device including a processor and non-transitory memory:
storing, in the non-transitory memory, a three-dimensional scene model of a physical environment including a plurality of points, wherein each of the plurality of points is associated with a set of coordinates in a three-dimensional space, wherein a subset of the plurality of points is associated with a hierarchical data set including a plurality of layers;
receiving, from an objective-effectuator, a request for a portion of the three-dimensional scene model, wherein the portion of the three-dimensional scene model includes less than all of the plurality of points or less than all of the plurality of layers;
obtaining, by the processor from the non-transitory memory, the portion of the three-dimensional scene model; and
providing, to the objective-effectuator, the portion of the three-dimensional scene model.

2. The method of claim 1, wherein the device includes a display, wherein the method further comprises:
receiving, from the objective-effectuator, an action based on the portion of the three-dimensional scene model; and
displaying, on the display, a representation of the objective-effectuator performing the action.

3. The method of claim 1, wherein the device includes a communications interface and receiving the request for the portion of the three-dimensional scene model includes receiving the request via the communications interface.

4. The method of claim 1, wherein the request for the portion of the three-dimensional scene model includes a request for a portion of the three-dimensional scene model within a distance of a representation of the objective-effectuator.

5. The method of claim 1, wherein the request for the portion of the three-dimensional scene model includes a request for a spatially down-sampled version of the three-dimensional scene model.

6. The method of claim 1, wherein the hierarchical data set includes a hierarchy of semantic labels and the request for the portion of the three-dimensional scene model includes a request for less than all the layers of the hierarchy of semantic labels.

7. The method of claim 1, wherein the hierarchical data set includes a hierarchy of spatial relationships and the request for the portion of the three-dimensional scene model includes a request for less than all the layers of the hierarchy of spatial relationships.

8. The method of claim 1, wherein the request for the portion of the three-dimensional scene model is based on a current objective of the objective-effectuator.

9. The method of claim 1, wherein the request for the portion of the three-dimensional scene model is based on one or more inherent attributes of the objective-effectuator.

10. The method of claim 1, wherein the request for the portion of the three-dimensional scene model is based on a current application including a representation of the objective-effectuator.

11. A device comprising:
a non-transitory memory; and
one or more processors to:
store, in the non-transitory memory, a three-dimensional scene model of a physical environment including a plurality of points, wherein each of the plurality of points is associated with a set of coordinates in a three-dimensional space, wherein a subset of the plurality of points is associated with a hierarchical data set including a plurality of layers;
receive, from an objective-effectuator, a request for a portion of the three-dimensional scene model, wherein the portion of the three-dimensional scene model includes less than all of the plurality of points or less than all of the plurality of layers;
obtain, from the non-transitory memory, the portion of the three-dimensional scene model; and
provide, to the objective-effectuator, the portion of the three-dimensional scene model.

12. The device of claim 11, further comprising a display, wherein the one or more processors are further to:
receive, from the objective-effectuator, an action based on the portion of the three-dimensional scene model; and
display, on the display, a representation of the objective-effectuator performing the action.

13. The device of claim 11, further comprising a communications interface, wherein the one or more processors are to receive the request for the portion of the three-dimensional scene model via the communications interface.

14. The device of claim 11, wherein the request for the portion of the three-dimensional scene model includes a request for a portion of the three-dimensional scene model within a distance of a representation of the objective-effectuator.

15. The device of claim 11, wherein the request for the portion of the three-dimensional scene model includes a request for a spatially down-sampled version of the three-dimensional scene model.

16. The device of claim 11, wherein the hierarchical data set includes a hierarchy of semantic labels and the request for the portion of the three-dimensional scene model includes a request for less than all the layers of the hierarchy of semantic labels.

17. The device of claim 11, wherein the hierarchical data set includes a hierarchy of spatial relationships and the request for the portion of the three-dimensional scene model includes a request for less than all the layers of the hierarchy of spatial relationships.

18. The device of claim 11, wherein the request for the portion of the three-dimensional scene model is based on a current objective or one or more inherent attributes of the objective-effectuator.

19. The device of claim 11, wherein the request for the portion of the three-dimensional scene model is based on a current application including a representation of the objective-effectuator.

20. A non-transitory memory storing one or more programs, which, when executed by one or more processors of a device, cause the device to:
store, in the non-transitory memory, a three-dimensional scene model of a physical environment including a plurality of points, wherein each of the plurality of points is associated with a set of coordinates in a three-dimensional space, wherein a subset of the plurality of points is associated with a hierarchical data set including a plurality of layers;
receive, from an objective-effectuator, a request for a portion of the three-dimensional scene model, wherein the portion of the three-dimensional scene model includes less than all of the plurality of points or less than all of the plurality of layers;
obtain, from the non-transitory memory, the portion of the three-dimensional scene model; and
provide, to the objective-effectuator, the portion of the three-dimensional scene model.
